(19) United States
(12) Patent Application Publication
(10) Pub. No.: US 2005/0162795 A1
(43) Pub. Date: Jul. 28, 2005

(54) Motor vehicle

(75) Inventor: Heinz Leiber, Oberriexingen (DE)

Correspondence Address: REED SMITH LLP;Suite 1400, 3110 Fairview Park Drive, Falls Church, VA, 22042, US

(73) Assignee: Intedis Gmbh & Co., KG

(21) Appl. No.: 11/081,680

(22) Filed: Mar. 17, 2005

(30) Foreign Application Priority Data
Sep. 20, 2002 (DE) 102 43 970.2
Sep. 22, 2003 (WO) PCT/DE03/03155
Sep. 22, 2003 (WO) 2004/028862A1

(51) Int. Cl. H02H 3/08

(52) U.S. Cl. 361/93.1

(57) ABSTRACT

The invention relates to a motor vehicle with an electrical distribution system, wherein at least one line is provided with a fuse element to protect the line against overcurrents, and wherein the fuse element consists of a measuring element for measuring the current flowing in the line, a separating element for interrupting the line, and an evaluator, and wherein the current measured by the measuring element with the fuse element functioning is evaluated in the evaluator according to an algorithm, and the separating element can be actuated to interrupt the line, depending on the evaluation result. The line branches into at least two partial lines after the fuse element with at least one consumer each, wherein the evaluator unit receives data for describing the operating state of the consumers in the partial lines, and these data are taken into account when evaluating the current measured by the measuring element.

The invention relates to a motor vehicle with an electrical distribution system according to the preamble of the independent main claims.

The fuse boxes in motor vehicles take up a lot of space. The number of fuses distributed among several fuse boxes averages over 50. If a fuse fails, the driver would have a hard time replacing it without closely studying the operating instructions. A distribution board would ideally not have any replaceable fuses.

These fuse boxes result in a dense bundling of the number of fuses with numerous lines to the consumers. The line to the consumer is often very long owing to the position of the fuse box.

The thick cable loom is difficult to install and secure, and in part requires punching large holes in the separating walls of the car body.

Modern-day fuse boxes only enable partial closed-circuit current management, if any, since the fuse does not know which current is flowing in the consumption loom.

Another disadvantage of today's fuse boxes that handle current distribution and line fusing operations is that fusing takes place only after an absolute short circuit. A partial short circuit, which often leads to smoldering fires, is not detected.

A generic motor vehicle in which so-called “intelligent” fuse elements are provided in the electrical distribution system is known from DE 100 09 775 A1, for example. To protect the line against overcurrents, the current flowing in the line or its direction is measured with a measuring element in this fuse element, and then evaluated in an evaluator. A separating element can be actuated to interrupt the line, depending on the evaluation result. Such fuse elements are suitable for replacing the previously conventional fusible links, and realizing an intelligent fusing characteristic.

Proceeding from this prior art, the object of this invention is to propose new embodiments of motor vehicles, in which preferably the entire electrical distribution system is provided with intelligent fuse elements.

This object is achieved by the motor vehicles according to the instruction in the two independent main claims.

Advantageous embodiments of the invention are described in the subclaims.

On the one hand, the invention is based on the basic idea of using the intelligent fuse elements to fuse lines that branch into several partial lines behind the fuse element in order to supply different consumers. The basic starting point here is that information about the operating status of the consumers, e.g., about whether a lamp is on or off, be relayed back to the fuse element. Information about the operating status of the consumers connected to the partial lines is taken into account during the evaluation of the current progression measured in the main line. This makes it possible to alter the characteristic of the fuse element, e.g., at which load threshold the fuse element trips the separating element and the line is interrupted, as a function of the operating status of the consumers connected to the partial line. For example, if the line branches into four partial lines, each connected to a lamp with a specific power consumption, which of the four lamps is currently activated can be taken into account when measuring the current load in the main line. The threshold for tripping the separating element is then adjusted as a function of the number of activated lamps. As a result, this intelligent fusing of the main line taking into account the consumers connected in the partial lines makes it possible to reduce the number of necessary fuse elements.

Another aspect of the invention is that the chronological current progression is always taken into account in a specific time interval Δt while evaluating the measured current progression. The current progression recorded over time can be classified and recognized as a critical or uncritical load condition in a suitable evaluation process, e.g., by comparing patterns with known current progression patterns, characterizing a short-circuit current, the startup behavior of a drive motor, or the response behavior of a polyswitch, for example.

In addition, the possible current load on the line can be reproduced far more precisely in comparison to the fusible link, so that the line can be optimized in the branched current paths, enabling a significant reduction in weight.

An exemplary embodiment according to the invention will be described in greater detail based on the drawing.

Shown in:

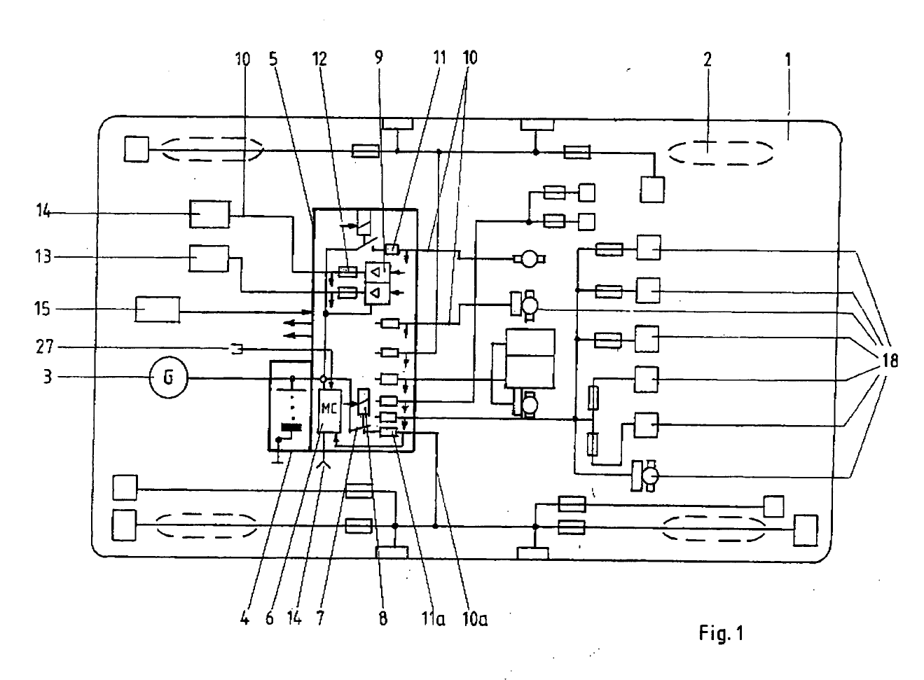

FIG. 1 is one possible configuration of the motor vehicle electronics according to the invention;

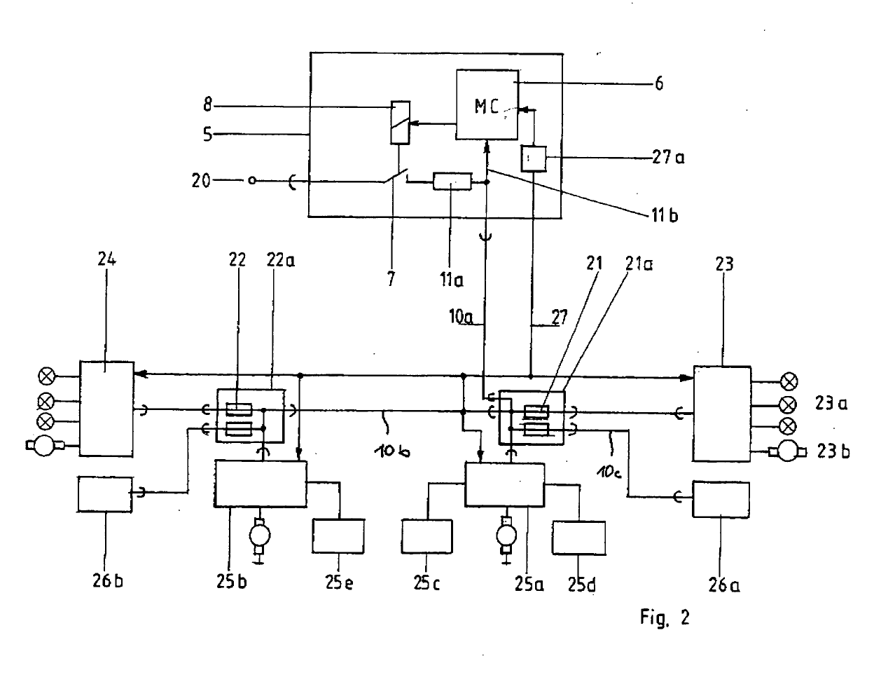

FIG. 2 is the expanded configuration of a time-delay branch;

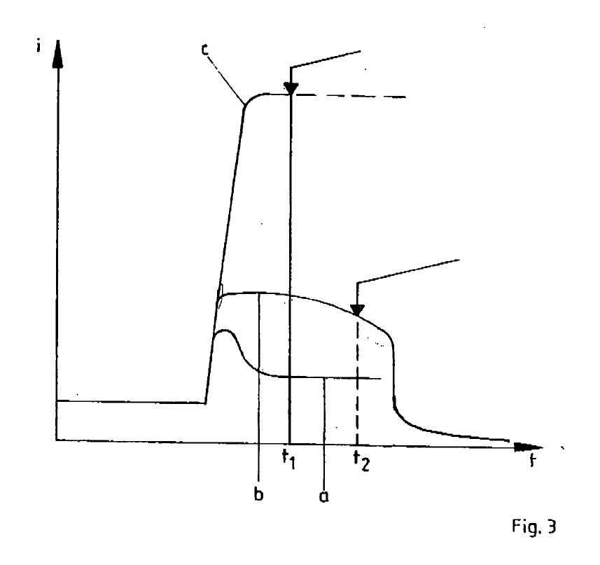

FIG. 3 are diagrams for explaining the invention;

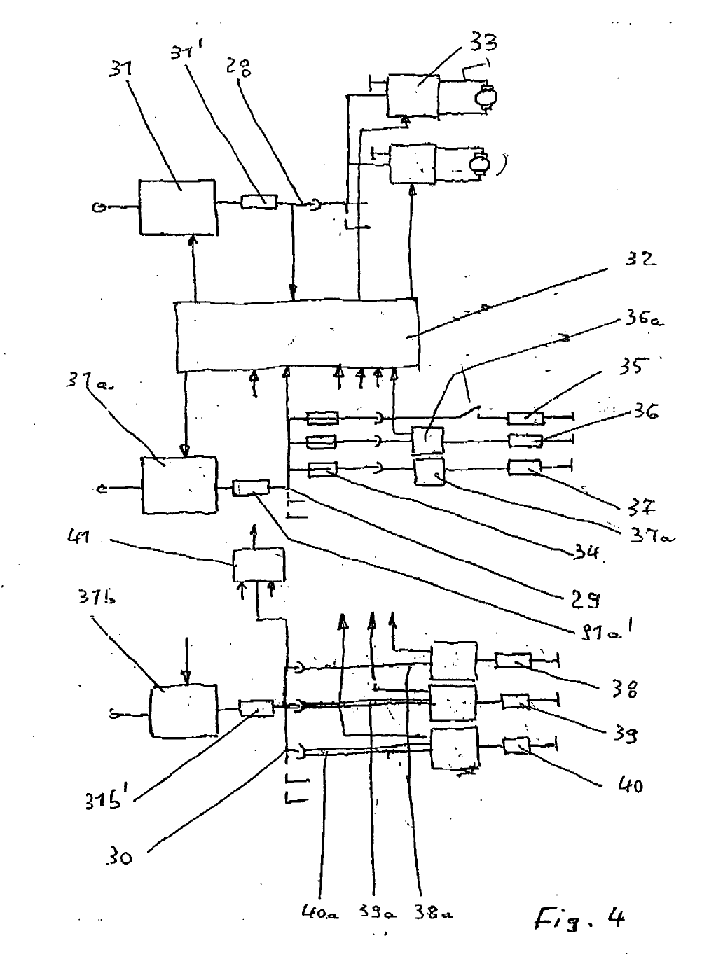

FIG. 4 is another possible configuration of the motor vehicle electronics according to the invention.

FIG. 1 provides a diagrammatic outline of a motor vehicle with the wheels. The vehicle 1 has a generator 3 and battery 4 for supplying its electrical consumers. The consumption current is relayed to a current distributor 5, which is designed as an intelligent current distributor.

It contains an evaluator, e.g., in the form of a microcomputer 6 (MC). The supply current is relayed via contacts 7, e.g., from relay 8, and via semiconductor switches 9 to a plurality of supply lines 10, to which one or more consumers are connected. For the sake of simplicity, FIG. 1 only shows the contact 7 for the supply branch 10a, to which a current measuring element, e.g., a shunt 11a, is connected. The circuit released at the latter is measured and processed by the microcomputer 6 using the shunt formed as a result. The remaining supply lines 10 are also allocated to separating elements like relays and resistors 11 or regeneratable fuses 12 (not shown). The currents flowing through the latter are determined, e.g., by means of the shunts 11 or 12, and relayed to the microcomputer 6, as indicated by the small arrows at the resistor outputs. The relay and shunt can also be replaced by semiconductor circuits with a current measuring element.

FIG. 2 shows the configuration expanded only for the supply branch 10a. In evidence are the battery connection 20, the microcomputer 6, the relay 8 with its contact 7, the resistor 11a and the feedback loop 11b to the MC6. The supply branch 10a supplies the left side of the vehicle. It is connected via regeneratable fuses 21 and 22 (e.g., PTC polyswitches) to a controller 23 on the front left, which supplies lamps 23a and a motor 23b for headlight adjustment, a controller 24 on the back left, which supplies corresponding lamps and an electric motor or other consumers, as well as blocks 26a and 26b, which are also controllers or other consumers.

The supply branch 10a directly supplies the door controllers 25a and 25b, which in turn supply the side-view mirror 25c and door locks 25d and 25e, so-called E-locks.

The controllers 23, 24, 25a and 25b are connected with the microcomputer 6 by means of a bus connection 27 and a can receiver 27a. This bus connection tells the microcomputer 6 which consumers are activated, so that it can even check whether the current flowing through the shunt 11a is plausible or not.

The PTC 21/22 are advantageously arranged in a distribution box 21a or 22a, and directly integrated into the cable loom. In cases, this can also take place using plug connectors or cables connected via insulation piercing connection device technology.

FIG. 3 shows the current progressions in various situations. Curve a shows the change in current when an additional lamp or a motor is activated. No shutdown takes place. Deactivation also does not occur when a progression according to curve b is recognized, which arises given a short circuit in a circuit with a regeneratable fuse, e.g., PTC. This circuit is here deactivated by the fuse. In the case of curve c, the microcomputer 6 detects the short circuit, and the corresponding branch is deactivated by the corresponding relay at t=1. The curve progressions are only shown qualitatively.

Arising short circuits are stored in diagnostic memory directly in the microcomputer or in a central diagnostic memory, and drawn upon by service personnel as valuable information during a fault search. A critical short circuit, e.g., as in the case of FIG. 3c, in which a line branch is deactivated, is best displayed via the bus connection in one of the vehicle displays. Since sporadic short circuits are often encountered, it makes sense to reactivate the line branch after a recovery interval or during each vehicle startup. The typically dropping current makes it possible to detect and store a short circuit at t=2 already.

In addition to the supply branch 10a, FIG. 1 shows a series of additional supply lines 10 with relays (not shown) for the most varied of consumers 18. Also provided are two supply circuits 10 with semiconductor switches 9, which are allocated to a safety system 14 (e.g., airbag) and an antitheft system 13 that require only low levels of current.

Consumers without interspersed separating elements can also be connected via PTC. In this case, it is advantageous to also activate a current measuring element (not shown) in the supply line from the battery to the current distributor 5, and provide an internal current distributor. This current measuring element can essentially also be used as a redundancy to the current measuring elements for the line branches, for example.

Possible supply branch classifications are listed in the following table:

Circuit
1: Right vehicle side
2: Left vehicle side
3: Cockpit
4: Roof
5: Motor controller
6: Dynamic drive system (EHB, ESP, ABS)
7: Power steering
8: Antitheft system
9: Airbag & safety systems
10: Telemetry

An HF antenna is also connected with the microcomputer 6, so that the signals from remote operation are routed directly to the current distributor 5. This is especially important in so-called keyless go systems, which require vary short reaction times in signal communication, wherein getting a network to respond after actuating the door handle is critical. In this case, the time-critical interrupt signals, e.g., from the door handle (connection 27), can be routed directly to the microcomputer 6 of the current distributor 5. FIG. 1 shows that the self-restoring fuses 12 are preferably integrated in branches of the supply lines 10. As already mentioned, the relays are bistable in design, at least in cases where closed-circuit current consumers are connected.

In this concept, it makes sense to integrate a closed-circuit current management, which is also controlled in the microcomputer 6 from the charge status of the battery (SOC). Since the entire current is monitored in the electrical distribution system, it is especially easy to realize a battery monitoring process according to the so-called SOC, SOH. This makes it possible to markedly reduce idle time caused by empty batteries.

FIG. 1 and the above table show that the number of supply lines is kept relatively low. The chronological progression of currents in the supply carriers 10 is monitored in the microcomputer 6. Deactivation takes place if a typical short circuit current is detected. The number of activated consumers as reported back by the controllers is taken into account while determining the magnitude of short circuit current. Any deactivation initiated in response to an implausible current is reported to a diagnostic memory.

It may be assumed that the controller outputs are inherently short-circuit-proof. The semiconductor switches 9 were used at low currents.

Consumer line activation may depend on the state of the vehicle (via block 15), e.g., vehicle open or closed; or on the use. For example, only the access authorization systems, e.g., central locking, etc., will preferably be actuated initially while opening the vehicle door or using the remote control for opening the doors via antenna 14.

Complete SOC monitoring requires that not just the entire consumer current be measured, but also the current delivered by the generator. In this case, the current measuring element (not shown) can be integrated into the generator regulator. The measured current value can be reported to the current regulator via a bus system. The microcomputer 6 can take over SOC computation here as well.

A critical battery state is reported via the bus system to a combined measuring device, for example.

FIG. 4 shows another embodiment of the circuit with different lines 28, 29 and 30, which provides separating elements 31, 31a and 31b along with current measuring elements 31′, 31′a and 31′b. The currents in the lines are evaluated by means of a central microcomputer 32, which serves as an evaluator. The separating elements 31, 31a and 31b are used as central monitors for several partial lines that branch from main lines 28, 29 and 30. The current paths in the main lines can be combined for a specific vehicle section, e.g., front left, front right, back left or back right.

The separating element 31 is a monitor for a current path that integrates a circuit breaker 33, e.g., a relay for motors or a power output stage. The job of the separating element 31 is to prevent short circuits in the lines or line position switches, which result in a deactivation in critical cases. The circuit breakers 33 are actuated by the microcomputer 32, so that its operating state is known in the microcomputer 32.

As soon as the line 28 carries a current, the latter is measured by the measuring device 31′, and the measuring result is relayed to the microcomputer 32. In the microcomputer 32, this measuring result is compared with an expected current level that depends on the number of circuit breakers 33 actuated by the microcomputer 32. If the measured current signal deviates from the expected current signal, the microcomputer 32 actuates the separating element 31 and cuts power to the entire line 28, so as to avoid damage to the lines or electrical components.

In the middle of FIG. 4, a separating element 31a is allocated to a larger number of polyswitches 34, which become very high-resistance given a short circuit, thereby protecting the corresponding downstream partial lines against short circuits.

The bottom part of the figure shows consumers 38, 39 and 40 with upstream controllers, wherein the various consumers require highly disparate currents that are also activated for different periods of time. In this case, the cross section of incoming lines 38a, 39a and 40a can be optimized, since the intelligent fusing with the separating element 31b, measuring element 31b′ and the microcomputer 32 ensures an intelligent fusing. Signal processing is here assisted by an ASIC 41, which prepares the chronological current evaluation and current path deactivation for the central evaluator circuit 32, for example.

1. A motor vehicle with an electrical distribution system, where at least one line is provided with a fuse element to protect the line against overcurrents, and wherein the fuse element consists of a measuring element for measuring the current flowing in the line, a separating element for interrupting the line, and an evaluator, and wherein the current measured by the measuring element with the fuse element functioning is evaluated in the evaluator according to an algorithm, and the separating element can be actuated to interrupt the line, depending on the evaluation result, characterized in that
the line branches into at least two partial lines after the fuse element with at least one consumer each, wherein the evaluator unit receives data for describing the operating state of the consumers in the partial lines, and these data are taken into account when evaluating the current measured by the measuring element.

2. The motor vehicle according to claim 1, characterized in that
the data for describing the operating state of the consumers in the partial lines are relayed to the evaluator via a bus connection.

3. A motor vehicle with an electrical distribution system, where at least one line is provided with a fuse element to protect the line against overcurrents, and wherein the fuse element consists of a measuring element for measuring the current flowing in the line, a separating element for interrupting the line, and an evaluator, and wherein the current measured by the measuring element with the fuse element functioning is evaluated in the evaluator according to an algorithm, and the separating element can be actuated to interrupt the line, depending on the evaluation result, characterized in that,
while measuring the current flowing in the line, the chronological current progression in a specific time interval Δt is measured and relayed to the evaluator, wherein the measured current progression is classified as a critical load state or uncritical load state during evaluation in the evaluator, and wherein the separating element is actuated to interrupt the line given a critical load state.

4. The motor vehicle according to claim 1, characterized in that
the evaluator is designed as a kind of microcomputer or ASIC.

5. The motor vehicle according to claim 1, characterized in that
the line incorporates fuses, e.g., polyswitches, that can be regenerated to individual consumers.

6. The motor vehicle according to claim 1, characterized in that
at least a part of the lines incorporates controllers with which individual downstream consumers can be activated and deactivated.

7. The motor vehicle according to claim 6, characterized in that
the controllers report the switching state of the individual consumers to the evaluator.

8. The motor vehicle according to claim 7, characterized in that
the connection between the evaluator and the controllers is a bus connection.

9. The motor vehicle according to claim 1, characterized in that
the number of lines is small, e.g., approx. 10.

10. The motor vehicle according to claim 1, characterized in that
the separating elements consist at least partially of relays.

11. The motor vehicle according to claim 10, characterized in that
the relays are at least partially bistable relays.

12. The motor vehicle according to claim 1, characterized in that
the separating elements consist at least partially of semiconductor switches.

13. The motor vehicle according to claim 12, characterized in that
the lines with semiconductor switches are additionally protected against short circuits by regeneratable fuses.

14. The motor vehicle according to claim 12, characterized in that safety and/or antitheft systems are connected to these lines.

15. The motor vehicle according to claim 1, characterized in that
the individual lines are enabled as a function of the vehicle state and/or current use.

16. The motor vehicle according to claim 15, characterized in that
only the access systems (central locking and the like) are activated when opening the door (door handle signals) and/or actuating the remote control for opening the door.

17. The motor vehicle according to claim 16, characterized in that the opening signals are relayed directly to the evaluator.

18. The motor vehicle according to claim 1, characterized in that
closed-circuit current management takes place via the evaluator circuit.

19. The motor vehicle according to claim 1, characterized in that
the evaluator monitors the battery charge state and the battery state.

20. The motor vehicle according to claim 1, characterized in that
the evaluator (microcomputer 6) sets up an allocated diagnostic memory location when a consumer branch is deactivated.

21. The motor vehicle according to claim 1, characterized in that
a current measuring element is additionally provided for the current from the battery to the distributor.

22. The motor vehicle according to claim 1, characterized in that
the deactivated supply branch is switched back on upon deactivation after a recognized short circuit from time to time, e.g., during any restart.

23. The motor vehicle according to claim 22, characterized in that
the reactivation does not take place, e.g., after the fifth time, if the short circuit persists.

24. The motor vehicle according to claim 1, characterized in that
several current distributors with evaluator units are used for the vehicle.

25. The motor vehicle according to claim 3, characterized in that
the evaluator is designed as a kind of microcomputer or ASIC.

26. The motor vehicle according to claim 3, characterized in that
the line incorporates fuses, e.g., polyswitches, that can be regenerated to individual consumers.

27. The motor vehicle according to claim 3, characterized in that
at least a part of the lines incorporates controllers with which individual downstream consumers can be activated and deactivated.

28. The motor vehicle according to claim 3, characterized in that
the number of lines is small, e.g., approx. 10.

29. The motor vehicle according to claim 3, characterized in that
the separating elements consist at least partially of relays.

30. The motor vehicle according to claim 3, characterized in that
the separating elements consist at least partially of semiconductor switches.

31. The motor vehicle according to claim 3, characterized in that
the individual lines are enabled as a function of the vehicle state and/or current use.

32. The motor vehicle according to claim 3, characterized in that
closed-circuit current management takes place via the evaluator circuit.

33. The motor vehicle according to claim 3, characterized in that
the evaluator monitors the battery charge state and the battery state.

34. The motor vehicle according to claim 3, characterized in that
the evaluator (microcomputer 6) sets up an allocated diagnostic memory location when a consumer branch is deactivated.

35. The motor vehicle according to claim 3, characterized in that
a current measuring element is additionally provided for the current from the battery to the distributor.

36. The motor vehicle according to claim 3, characterized in that
the deactivated supply branch is switched back on upon deactivation after a recognized short circuit from time to time, e.g., during any restart.

37. The motor vehicle according to claim 3, characterized in that
several current distributors with evaluator units are used for the vehicle.
